(19) United States
(12) Patent Application Publication
(10) Pub. No.: US 2024/0112326 A1
(43) Pub. Date: Apr. 4, 2024

(54) INSPECTION OF ADAPTIVE PATTERNED WORKPIECES WITH DYNAMIC DESIGN AND DEEP LEARNING-BASED RENDERING

(71) Applicant: KLA Corporation, Milpitas, CA (US)

(72) Inventors: Pavan Kumar Perali, San Ramon, CA (US); Sankar Muthukrishnan, Chennai (IN); Hemang Bhatt, Hillsboro, OR (US); Adithya Swaroop Sahadevareddy, Anantapur (IN)

(21) Appl. No.: 18/374,106

(22) Filed: Sep. 28, 2023

Related U.S. Application Data
(60) Provisional application No. 63/426,803, filed on Nov. 21, 2022.

(30) Foreign Application Priority Data
Sep. 30, 2022 (IN) 202241056424

(51) Int. Cl. G06T 7/00; G06T 5/50; G06V 10/24

(52) U.S. Cl. CPC G06T 7/001; G06T 5/50; G06T 7/0006; G06V 10/24; G06T 2207/20084; G06T 2207/20224; G06T 2207/30148; G06T 2207/30164

(57) ABSTRACT

A reference optical image of a die is determined based on a design file with a deep convolutional neural network for image-to-image translation. The reference optical image is subtracted from the target image thereby generating a difference image. After applying a care area mask, the difference image can be binarized. The resulting binarized defective image can be used for optical inspection.

### CROSS-REFERENCE TO RELATED APPLICATIONS

This application claims priority to Indian Patent App. No. 202241056424 filed Sep. 30, 2022 and U.S. App. No. 63/426,803 filed Nov. 21, 2022, the disclosures of which are hereby incorporated by reference.

### FIELD OF THE DISCLOSURE

This disclosure relates to optical inspection of workpieces such as semiconductor wafers.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a workpiece, such as a semiconductor wafer, using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Some workpieces include a die with multiple chips. Certain die designs with multiple chips, such as a system in package (SIP), a film frame carrier (FFC), or a 3D integrated circuit (3D IC) can make inspection difficult. Each die can print differently, which limits the ability to inspect by comparing neighboring devices.

Existing techniques use adjacent die subtraction or reference-based subtraction. These techniques need the images to be structurally similar and aligned with each other. Large amounts of nuisance tend to be generated when these techniques are run on a die with multiple chips. It can be difficult to suppress such high levels of nuisance. Nuisance can be reduced with improved alignment, but this generally uses manual alignment approaches that are tedious and time-consuming.

Therefore, improved methods and systems are needed.

### BRIEF SUMMARY OF THE DISCLOSURE

A method is provided in a first embodiment. The method includes receiving, at a processor, a target image of a workpiece that includes a die with a plurality of chips and a design file that includes a design of the die. Using the processor, a reference optical image of the die is generated based on the design file with a deep convolutional neural network for image-to-image translation. The reference optical image is subtracted from the target image using the processor thereby generating a difference image. Using the processor, a runtime care area mask for the die is generated based on the design file that includes the design of the die. Using the processor, the runtime care area mask is applied against the difference image thereby generating a masked difference image. Using the processor, a threshold is applied against the masked difference image thereby generating a binarized defective image. The die may include at least one SIP device, FFC, or 3D IC.

The deep convolutional neural network can be a cycle generative adversarial network.

The design file can be a graphic design system file.

The method can include aligning the target image and the reference optical image prior to the subtracting.

The method can include extracting, using the processor, a care area image from the target image using the runtime care area mask.

The method can include generating the target image using an optical inspection system.

A non-transitory computer readable medium storing a program can be configured to instruct the processor to execute the method of the first embodiment.

A system is provided in a second embodiment. The system includes a light source that generates a beam of light; a stage configured to hold a workpiece in a path of the beam of light; a detector configured to receive the beam of light reflected from the workpiece; and a processor in electronic communication with the detector. The workpiece includes a die with a plurality of chips. The processor is configured to: generate a target image of the workpiece based on information from the detector; receive a design file that includes a design of the die; generate a reference optical image of the die based on the design file with a deep convolutional neural network for image-to-image translation; subtract the reference optical image from the target image thereby generating a difference image; generate a runtime care area mask for the die based on the design file that includes the design of the die; apply the runtime care area mask against the difference image thereby generating a masked difference image; and apply a threshold against the masked difference image thereby generating a binarized defective image. The die may include at least one SIP device, FFC, or 3D IC.

The deep convolutional neural network can be a cycle generative adversarial network.

The design file can be a graphic design system file.

The processor can be further configured to align the target image and the reference optical image prior to the subtracting.

The processor can be further configured to extract a care area image from the target image using the runtime care area mask.

### DESCRIPTION OF THE DRAWINGS

For a fuller understanding of the nature and objects of the disclosure, reference should be made to the following detailed description taken in conjunction with the accompanying drawings, in which:

FIG. 1 is a an exemplary SIP device;

FIG. 2 is a flowchart of a method in accordance with the present disclosure; and

FIG. 3 is a diagram of an embodiment of an optical inspection system in accordance with the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

With adaptive patterning, each die prints and looks different. Embodiments disclosed herein use a design file that is different for each die and workpiece to detect defects on that workpiece using deep learning methods for optical image rendering and care area alignment. The alignment time constraint can be removed with the use of cycle generative adversarial network (CycleGAN) network for physics-based optical image rendering. These embodiments can help to identify defects on workpieces with adaptive die patterns by loading a design file dynamically and using deep learning-based rendering. Defect detection on adaptive die patterned workpieces is possible. Use of a physics-based reference generation with design files avoids training steps.

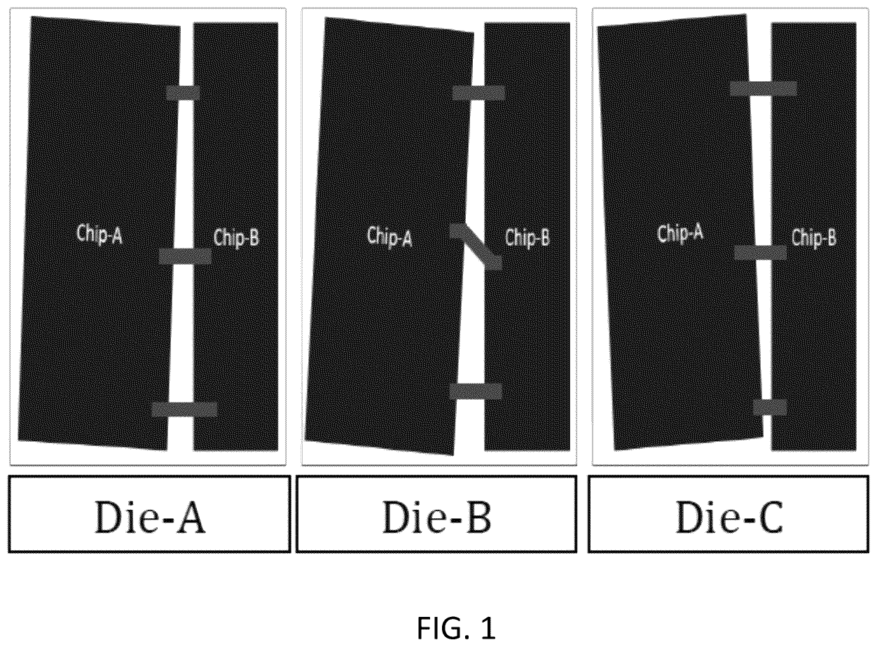

FIG. 1 is an exemplary SIP device. Multiple chips are included in a die. High-speed chip placement can cause translation and rotational offsets, as shown in FIG. 1. As seen in FIG. 1, Chip-A is positioned differently from Chip-B in Die-A, Die-B, and Die-C. Redistribution lines (RDLs) that connect these chips can be structurally adjusted based on the chip placement. The redistribution lines may be different when comparing two dies.

The die-to-die pattern variation seen in FIG. 1 causes problems during inspection. First, a static care area cannot be set during recipe creation. Second, previous die-to-die techniques that compare a target die against a neighboring die will not work because of the non-repeating structures. For example, as shown in FIG. 1, Die-A and Die-B are not the same. The difference in angle means that a static care area cannot be drawn for both dies.

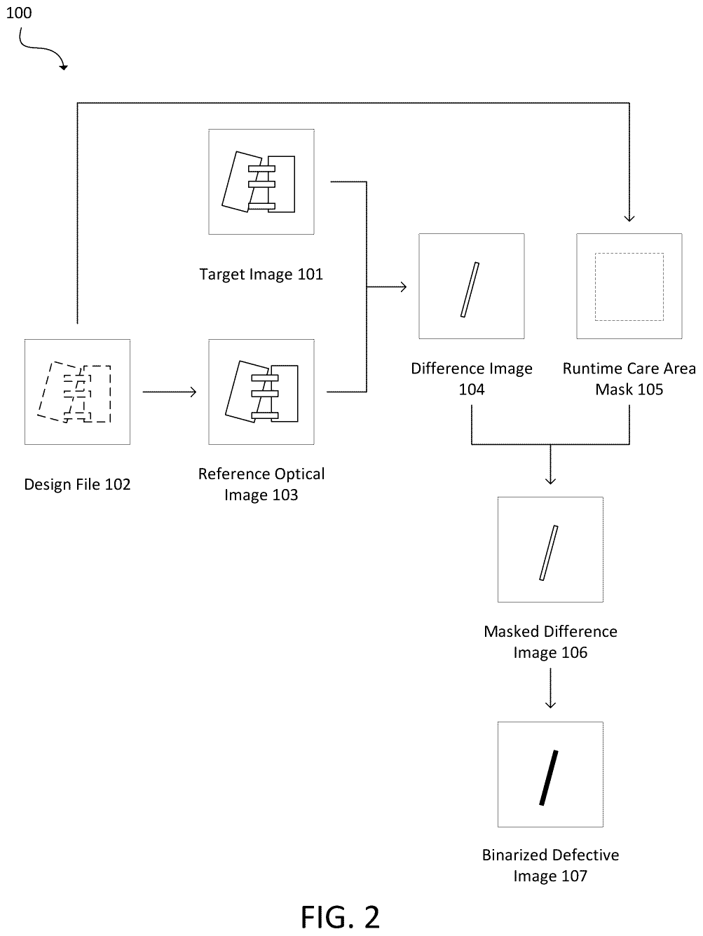

FIG. 2 is a flowchart of a method 100. Some or all of the steps in the method 100 can be performed using a processor.

A target image 101 is received. The target image 101 can be generated by, for example, an optical inspection system. The target image 101 can be of a workpiece include a die with multiple chips, such as a SIP device, an FFC device, a 3D IC device, or another type of device. A generic SIP device is shown in FIG. 2 for ease of illustration.

A design file 102 that corresponds to the die in the target image 101 also is received. The design file 102 represents planar geometric shapes, text labels, and other information about the layout of the die in hierarchical form. In an example, the design file 102 is a graphic design system (GDS) file, such as GDSII or OASIS. GDS is the graphics design system that contains the design information of workpiece or die. For standard wafers, the GDS can contain a die level design, but for the workpieces with adaptive die patterning, the GDS may contain a workpiece level design that is different for every workpiece or that has different die designs at the die level. The design file 102 may be a model die or the particular die that needs to be used in the method 100.

Using the design file 102, a reference optical image 103 is generated using a deep convolutional neural network with image-to-image translation. Image-to-image translation maps an input image and an output image so that the output image can be used to perform specific tasks. For example, an image can be transformed from one domain to another domain to learn the mapping between the two images. Image-to-image translation can be used for image synthesis, noise reduction, or other purposes. These activities can be performed using a cycle generative adversarial network. Each die can have a different reference optical image 103 generated. The cycle generative adversarial network can be CycleGAN, Pix2Pix, or other types of generative adversarial networks models. Pix2Pix uses aligned and paired data for training. CycleGAN can be trained with an unpaired data set. Pairing means that images of source and target domain should be of same location and that a number of images of both the domains should be same.

Pix2Pix is a generative adversarial network (GAN) model designed for general purpose image-to-image translation. The Pix2Pix model is a conditional GAN. Generation of the output image is conditional on an input, such as a source image. The discriminator is provided with a source image and the target image and determines whether the target is a plausible transformation of the source image. The generator is trained via adversarial loss, which encourages the generator to generate plausible images in the target domain. The Pix2Pix GAN can perform image-to-image translation tasks like generating an image from a different image (e.g., a detailed image from a sketch, design, or blueprint).

CycleGAN is an image-to-image translation model like Pix2Pix. Unlike Pix2Pix, CycleGAN learns mapping between input and output images using unpaired dataset. Like Pix2Pix, CycleGAN can generate an image from a different image (e.g., a detailed image from a sketch, design, or blueprint).

Rooted in neural network technology, deep learning is a probabilistic graph model with many neuron layers, commonly known as a deep architecture. Deep learning technology processes the information such as image, text, voice, and so on in a hierarchical manner. In using deep learning in the present disclosure, feature extraction is accomplished automatically using learning from data. For example, defects can be classified, sorted, or binned using the deep learning classification module based on the one or more extracted features.

Generally speaking, deep learning (also known as deep structured learning, hierarchical learning or deep machine learning) is a branch of machine learning based on a set of algorithms that attempt to model high level abstractions in data. In a simple case, there may be two sets of neurons: ones that receive an input signal and ones that send an output signal. When the input layer receives an input, it passes on a modified version of the input to the next layer. In a deep network, there are many layers between the input and output, allowing the algorithm to use multiple processing layers, composed of multiple linear and non-linear transformations.

Deep learning is part of a broader family of machine learning methods based on learning representations of data. An observation (e.g., a feature to be extracted for reference) can be represented in many ways such as a vector of intensity values per pixel or in a more abstract way like a set of edges, regions of particular shape, etc. Some representations are better than others at simplifying the learning task (e.g., face recognition or facial expression recognition). Deep learning can provide efficient algorithms for unsupervised or semi-supervised feature learning and hierarchical feature extraction.

In an embodiment, the deep learning model is configured as a neural network. In a further embodiment, the deep learning model may be a deep neural network with a set of weights that model the world according to the data that it has been fed to train it. Neural networks can be generally defined as a computational approach based on a relatively large collection of neural units loosely modeling the way a biological brain solves problems with relatively large clusters of biological neurons connected by axons. Each neural unit is connected with many others, and links can be enforcing or inhibitory in their effect on the activation state of connected neural units. These systems are self-learning and trained rather than explicitly programmed and excel in areas where the solution or feature detection is difficult to express in a traditional computer program.

Neural networks typically include multiple layers, and the signal path traverses from front to back. The goal of the neural network is to solve problems in the same way that the human brain would, although several neural networks are much more abstract. Modern neural network projects typically work with a few thousand to a few million neural units and millions of connections. The neural network may have any suitable architecture and/or configuration known in the art.

GANs provide generative modeling using deep learning methods, such as convolutional neural networks. Generative modeling is an unsupervised learning task in machine learning that involves automatically discovering and learning the regularities or patterns in input data so that the model can be used to generate or output new examples that plausibly could have been determined from the original dataset.

GANs train a generative model by framing the problem as a supervised learning problem with two sub-models. First, there is a generator model that is trained to generate new examples. Second, there is a discriminator model that tries to classify examples as either real (from the domain) or fake (generated). The two models are trained together in a zero-sum game (i.e., adversarial) until the discriminator model is fooled enough that the generator model is generating plausible examples.

A region of the design file 102 that corresponds to the optical image 101 can be used in method 100. The features of the die may be in both the design file 102 and the optical image 101.

The deep convolutional neural network can be trained to map the design file 102 images to the target image 101 and generate the reference optical image 103. This learning does not typically require perfect alignment. A rough location in the design file 102 and the target image 101 is generally enough to learn the network parameters. During runtime, the corresponding GDS portion of the target die is obtained from the design file 102 and then converted to the reference optical image 103 using the model trained during recipe creation. The reference optical image 103 is used as reference image, aligned, and compared with the target image 101 to detect the anomalies. Manual alignment at setup or between the target image 101 and reference optical image 103 can be avoided.

An infrastructure with high performance computing accelerators (e.g., graphics processing unit (GPU)) may be used to train the network with examples of design clips and images.

The reference optical image 103 can be generated from the design file 102 in real-time or otherwise as-needed.

The reference optical image 103 is then subtracted from the target image 101 using image subtraction. This generates a difference image 104. The image subtraction can be performed using the same neural network, a different neural network, or a conventional processor. As shown in FIG. 2, the image subtraction results in a difference image 104 with a slight difference between the target image 101 and the reference optical image 103.

Prior to the image subtraction, the target image 101 can optionally be aligned to the reference optical image 103. This may not be necessary based on the reference optical image 103 that is generated.

The design file 102 also is optionally used to generate a runtime care area mask 105. The runtime care area mask 105 includes the design of the die in the target image 101. The runtime care area mask 105 also can exclude areas that have high noise or that are not the focus of the inspection. Each die can have a different runtime care area mask 105 generated.

Optionally, the runtime care area mask 105 is applied against the difference image 104, which generates a masked difference image 106. The masked difference image 106 can mask (or exclude) parts of the difference image 104, such as areas not to be inspected, areas that rarely include defects, or areas that are known to lead to false positives during inspection.

A threshold can be applied against the masked difference image 106. This step generates a binarized defective image 107 that can be used for optical inspection. The binarized defective image can include pixels with two colors, such as black and white. The threshold can be used to determine which pixels are designated as one of the two colors. In an instance, post-processing, such as filtering and merging the candidate defective pixels in the binarized defective image 107, can provide defect information for all sites.

Optionally, a care area image can be extracted from the target image 101 using the runtime care area mask 105. The resulting image can be used for optical inspection or for comparison with the binarized defective image 107. The runtime care area mask 105 also can be applied prior to one or both of the images used image subtraction that results in the difference image 104.

In an example, a user created a recipe using the layer design information with gross alignment. The deep convolutional neural network learned the network parameters to render the reference optical image.

At runtime, the design file is dynamically loaded for each workpiece and optical reference images are rendered using the deep convolutional neural network. A high performance computing node configuration or central processing unit (CPU) cluster can be used. This rendered optical reference image is used to update the design-based care areas to the runtime optical images and also directly used for detecting anomalies.

In an embodiment, a deep learning-based classifier can reduce the nuisances and separate defects of interest (DOI) in the binarized defective image 107.

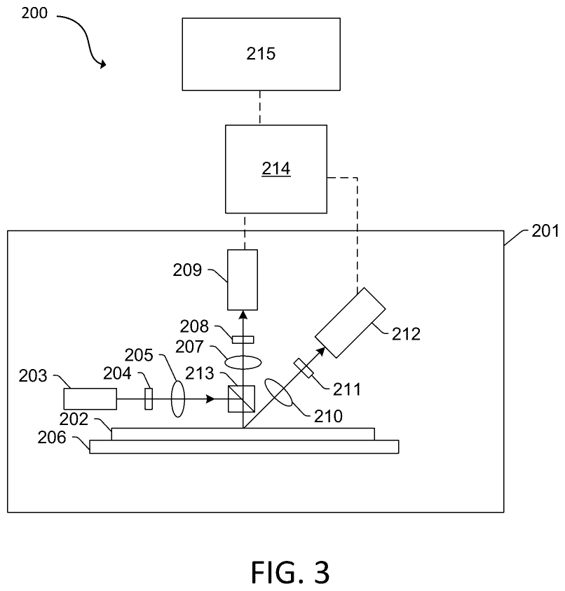

One embodiment of an optical inspection system 200 is shown in FIG. 3. The system 200 includes optical based subsystem 201. In general, the optical based subsystem 201 is configured for generating optical based output for a specimen 202 by directing light to (or scanning light over) and detecting light from the specimen 202. In one embodiment, the specimen 202 includes a wafer. The wafer may include any wafer known in the art, such as those used in the method 100. In another embodiment, the specimen 202 includes a reticle. The reticle may include any reticle known in the art.

In the embodiment of the system 200 shown in FIG. 3, optical based subsystem 201 includes an illumination subsystem configured to direct light to specimen 202. The illumination subsystem includes at least one light source. For example, as shown in FIG. 3, the illumination subsystem includes light source 203. In one embodiment, the illumination subsystem is configured to direct the light to the specimen 202 at one or more angles of incidence, which may include one or more oblique angles and/or one or more normal angles. For example, as shown in FIG. 3, light from light source 203 is directed through optical element 204 and then lens 205 to specimen 202 at an oblique angle of incidence. The oblique angle of incidence may include any suitable oblique angle of incidence, which may vary depending on, for instance, characteristics of the specimen 202.

The optical based subsystem 201 may be configured to direct the light to the specimen 202 at different angles of incidence at different times. For example, the optical based subsystem 201 may be configured to alter one or more characteristics of one or more elements of the illumination subsystem such that the light can be directed to the specimen 202 at an angle of incidence that is different than that shown in FIG. 3. In one such example, the optical based subsystem 201 may be configured to move light source 203, optical element 204, and lens 205 such that the light is directed to the specimen 202 at a different oblique angle of incidence or a normal (or near normal) angle of incidence.

In some instances, the optical based subsystem 201 may be configured to direct light to the specimen 202 at more than one angle of incidence at the same time. For example, the illumination subsystem may include more than one illumination channel, one of the illumination channels may include light source 203, optical element 204, and lens 205 as shown in FIG. 3 and another of the illumination channels (not shown) may include similar elements, which may be configured differently or the same, or may include at least a light source and possibly one or more other components such as those described further herein. If such light is directed to the specimen at the same time as the other light, one or more characteristics (e.g., wavelength, polarization, etc.) of the light directed to the specimen 202 at different angles of incidence may be different such that light resulting from illumination of the specimen 202 at the different angles of incidence can be discriminated from each other at the detector(s).

In another instance, the illumination subsystem may include only one light source (e.g., light source 203 shown in FIG. 3) and light from the light source may be separated into different optical paths (e.g., based on wavelength, polarization, etc.) by one or more optical elements (not shown) of the illumination subsystem. Light in each of the different optical paths may then be directed to the specimen 202. Multiple illumination channels may be configured to direct light to the specimen 202 at the same time or at different times (e.g., when different illumination channels are used to sequentially illuminate the specimen). In another instance, the same illumination channel may be configured to direct light to the specimen 202 with different characteristics at different times. For example, in some instances, optical element 204 may be configured as a spectral filter and the properties of the spectral filter can be changed in a variety of different ways (e.g., by swapping out the spectral filter) such that different wavelengths of light can be directed to the specimen 202 at different times. The illumination subsystem may have any other suitable configuration known in the art for directing the light having different or the same characteristics to the specimen 202 at different or the same angles of incidence sequentially or simultaneously.

In one embodiment, light source 203 may include a broadband plasma (BBP) source. In this manner, the light generated by the light source 203 and directed to the specimen 202 may include broadband light. However, the light source may include any other suitable light source such as a laser. The laser may include any suitable laser known in the art and may be configured to generate light at any suitable wavelength or wavelengths known in the art. In addition, the laser may be configured to generate light that is monochromatic or nearly-monochromatic. In this manner, the laser may be a narrowband laser. The light source 203 may also include a polychromatic light source that generates light at multiple discrete wavelengths or wavebands.

Light from optical element 204 may be focused onto specimen 202 by lens 205. Although lens 205 is shown in FIG. 3 as a single refractive optical element, it is to be understood that, in practice, lens 205 may include a number of refractive and/or reflective optical elements that in combination focus the light from the optical element to the specimen. The illumination subsystem shown in FIG. 3 and described herein may include any other suitable optical elements (not shown). Examples of such optical elements include, but are not limited to, polarizing component(s), spectral filter(s), spatial filter(s), reflective optical element(s), apodizer(s), beam splitter(s) (such as beam splitter 213), aperture(s), and the like, which may include any such suitable optical elements known in the art. In addition, the optical based subsystem 201 may be configured to alter one or more of the elements of the illumination subsystem based on the type of illumination to be used for generating the optical based output.

The optical based subsystem 201 may also include a scanning subsystem configured to cause the light to be scanned over the specimen 202. For example, the optical based subsystem 201 may include stage 206 on which specimen 202 is disposed during optical based output generation. The scanning subsystem may include any suitable mechanical and/or robotic assembly (that includes stage 206) that can be configured to move the specimen 202 such that the light can be scanned over the specimen 202. In addition, or alternatively, the optical based subsystem 201 may be configured such that one or more optical elements of the optical based subsystem 201 perform some scanning of the light over the specimen 202. The light may be scanned over the specimen 202 in any suitable fashion such as in a serpentine-like path or in a spiral path.

The optical based subsystem 201 further includes one or more detection channels. At least one of the one or more detection channels includes a detector configured to detect light from the specimen 202 due to illumination of the specimen 202 by the subsystem and to generate output responsive to the detected light. For example, the optical based subsystem 201 shown in FIG. 3 includes two detection channels, one formed by collector 207, element 208, and detector 209 and another formed by collector 210, element 211, and detector 212. As shown in FIG. 3, the two detection channels are configured to collect and detect light at different angles of collection. In some instances, both detection channels are configured to detect scattered light, and the detection channels are configured to detect light that is scattered at different angles from the specimen 202. However, one or more of the detection channels may be configured to detect another type of light from the specimen 202 (e.g., reflected light).

As further shown in FIG. 3, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 210, element 211, and detector 212 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 3 shows an embodiment of the optical based subsystem 201 that includes two detection channels, the optical based subsystem 201 may include a different number of detection channels (e.g., only one detection channel or two or more detection channels). In one such instance, the detection channel formed by collector 210, element 211, and detector 212 may form one side channel as described above, and the optical based subsystem 201 may include an additional detection channel (not shown) formed as another side channel that is positioned on the opposite side of the plane of incidence. Therefore, the optical based subsystem 201 may include the detection channel that includes collector 207, element 208, and detector 209 and that is centered in the plane of incidence and configured to collect and detect light at scattering angle(s) that are at or close to normal to the specimen 202 surface. This detection channel may therefore be commonly referred to as a “top” channel, and the optical based subsystem 201 may also include two or more side channels configured as described above. As such, the optical based subsystem 201 may include at least three channels (i.e., one top channel and two side channels), and each of the at least three channels has its own collector, each of which is configured to collect light at different scattering angles than each of the other collectors.

As described further above, each of the detection channels included in the optical based subsystem 201 may be configured to detect scattered light. Therefore, the optical based subsystem 201 shown in FIG. 3 may be configured for dark field (DF) output generation for specimens 202. However, the optical based subsystem 201 may also or alternatively include detection channel(s) that are configured for bright field (BF) output generation for specimens 202. In other words, the optical based subsystem 201 may include at least one detection channel that is configured to detect light specularly reflected from the specimen 202. Therefore, the optical based subsystems 201 described herein may be configured for only DF, only BF, or both DF and BF imaging. Although each of the collectors are shown in FIG. 3 as single refractive optical elements, it is to be understood that each of the collectors may include one or more refractive optical die(s) and/or one or more reflective optical element(s).

The one or more detection channels may include any suitable detectors known in the art. For example, the detectors may include photo-multiplier tubes (PMTs), charge coupled devices (CCDs), time delay integration (TDI) cameras, and any other suitable detectors known in the art. The detectors may also include non-imaging detectors or imaging detectors. In this manner, if the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels of the optical based subsystem may be signals or data, but not image signals or image data. In such instances, a processor such as processor 214 may be configured to generate images of the specimen 202 from the non-imaging output of the detectors. However, in other instances, the detectors may be configured as imaging detectors that are configured to generate imaging signals or image data. Therefore, the optical based subsystem may be configured to generate optical images or other optical based output described herein in a number of ways.

It is noted that FIG. 3 is provided herein to generally illustrate a configuration of an optical based subsystem 201 that may be included in the system embodiments described herein or that may generate optical based output that is used by the system embodiments described herein. The optical based subsystem 201 configuration described herein may be altered to optimize the performance of the optical based subsystem 201 as is normally performed when designing a commercial output acquisition system. In addition, the systems described herein may be implemented using an existing system (e.g., by adding functionality described herein to an existing system). For some such systems, the methods described herein may be provided as optional functionality of the system (e.g., in addition to other functionality of the system). Alternatively, the system described herein may be designed as a completely new system.

The processor 214 may be coupled to the components of the system 200 in any suitable manner (e.g., via one or more transmission media, which may include wired and/or wireless transmission media) such that the processor 214 can receive output. The processor 214 may be configured to perform a number of functions using the output. The system 200 can receive instructions or other information from the processor 214. The processor 214 and/or the electronic data storage unit 215 optionally may be in electronic communication with a wafer inspection tool, a wafer metrology tool, or a wafer review tool (not illustrated) to receive additional information or send instructions. For example, the processor 214 and/or the electronic data storage unit 215 can be in electronic communication with a scanning electron microscope.

The processor 214, other system(s), or other subsystem(s) described herein may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 214 and electronic data storage unit 215 may be disposed in or otherwise part of the system 200 or another device. In an example, the processor 214 and electronic data storage unit 215 may be part of a standalone control unit or in a centralized quality control unit. Multiple processors 214 or electronic data storage units 215 may be used.

The processor 214 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 214 to implement various methods and functions may be stored in readable storage media, such as a memory in the electronic data storage unit 215 or other memory.

If the system 200 includes more than one processor 214, then the different subsystems may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 214 may be configured to perform a number of functions using the output of the system 200 or other output. For instance, the processor 214 may be configured to send the output to an electronic data storage unit 215 or another storage medium. The processor 214 may be configured according to any of the embodiments described herein. The processor 214 also may be configured to perform other functions or additional steps using the output of the system 200 or using images or data from other sources.

Various steps, functions, and/or operations of system 200 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor 214 or, alternatively, multiple processors 214. Moreover, different sub-systems of the system 200 may include one or more computing or logic systems. Therefore, the above description should not be interpreted as a limitation on the present disclosure but merely an illustration.

In an instance, the processor 214 is in communication with the system 200. The processor 214 is configured to generate a target image of the workpiece based on information from the detector 209 and/or detector 212. The die can include at least one SIP device, a FFC device, or a 3D IC device. The processor 214 also receives a design file that includes a design of the die. The design file can be a graphic design system file. A reference optical image of the die is generated by the processor 214 based on the design file with a deep convolutional neural network for image-to-image translation. The deep convolutional neural network may be a CycleGAN. The processor 214 is also configured to subtract the reference optical image from the target image thereby generating a difference image; generate a runtime care area mask for the die based on the design file that includes the design of the die; apply the runtime care area mask against the difference image thereby generating a masked difference image; and apply a threshold against the masked difference image thereby generating a binarized defective image.

The processor can be further configured to align the target image and the reference optical image prior to the subtracting.

The processor can be further configured to extract a care area image from the target image using the runtime care area mask.

An additional embodiment relates to a non-transitory computer-readable medium storing program instructions executable on a controller for performing a computer-implemented method for inspection, as disclosed herein. In particular, as shown in FIG. 3, electronic data storage unit 215 or other storage medium may contain non-transitory computer-readable medium that includes program instructions executable on the processor 214. The computer-implemented method may include any step(s) of any method(s) described herein, including method 100.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (MFC), Streaming SIMD Extension (SSE), or other technologies or methodologies, as desired.

Each of the steps of the method may be performed as described herein. The methods also may include any other step(s) that can be performed by the processor and/or computer subsystem(s) or system(s) described herein. The steps can be performed by one or more computer systems, which may be configured according to any of the embodiments described herein. In addition, the methods described above may be performed by any of the system embodiments described herein.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
receiving, at a processor, a target image of a workpiece that includes a die with a plurality of chips;
receiving, at the processor, a design file that includes a design of the die;
generating, using the processor, a reference optical image of the die based on the design file with a deep convolutional neural network for image-to-image translation;
subtracting the reference optical image from the target image using the processor thereby generating a difference image;
generating, using the processor, a runtime care area mask for the die based on the design file that includes the design of the die;
applying, using the processor, the runtime care area mask against the difference image thereby generating a masked difference image; and
applying, using the processor, a threshold against the masked difference image thereby generating a binarized defective image.

2. The method of claim 1, wherein the die includes at least one system in package device.

3. The method of claim 1, wherein the die includes a film frame carrier.

4. The method of claim 1, wherein the die includes a 3D integrated circuit.

5. The method of claim 1, wherein the deep convolutional neural network is a cycle generative adversarial network.

6. The method of claim 1, wherein the design file is a graphic design system file.

7. The method of claim 1, further comprising aligning the target image and the reference optical image prior to the subtracting.

8. The method of claim 1, further comprising extracting, using the processor, a care area image from the target image using the runtime care area mask.

9. The method of claim 1, further comprising generating the target image using an optical inspection system.

10. A non-transitory computer readable medium storing a program configured to instruct the processor to execute the method of claim 1.

11. A system comprising:
a light source that generates a beam of light;
a stage configured to hold a workpiece in a path of the beam of light, wherein the workpiece includes a die with a plurality of chips;
a detector configured to receive the beam of light reflected from the workpiece; and
a processor in electronic communication with the detector, wherein the processor is configured to:
generate a target image of the workpiece based on information from the detector;
receive a design file that includes a design of the die;
generate a reference optical image of the die based on the design file with a deep convolutional neural network for image-to-image translation;
subtract the reference optical image from the target image thereby generating a difference image;
generate a runtime care area mask for the die based on the design file that includes the design of the die;
apply the runtime care area mask against the difference image thereby generating a masked difference image; and
apply a threshold against the masked difference image thereby generating a binarized defective image.

12. The system of claim 11, wherein the die includes at least one system in package device, a film frame carrier, or a 3D integrated circuit.

13. The system of claim 11, wherein the deep convolutional neural network is a cycle generative adversarial network.

14. The system of claim 11, wherein the design file is a graphic design system file.

15. The system of claim 11, wherein the processor is further configured to align the target image and the reference optical image prior to the subtracting.

16. The system of claim 11, wherein the processor is further configured to extract a care area image from the target image using the runtime care area mask.
